(19) United States
(12) Patent Application Publication
(10) Pub. No.: US 2006/0293053 A1
(43) Pub. Date: Dec. 28, 2006

(54) Silent wireless communication system and method

(76) Inventor: Farouk M. Zanaty, Palm Bay, FL (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/166,083

(22) Filed: Jun. 27, 2005

(51) Int. Cl. H04Q 7/20

(52) U.S. Cl. 455/436

(57) ABSTRACT

A method of processing data through handover communications in one or more mobile devices that is in a standby mode within a cell of a mobile telecommunications network according to neighboring lists of other mobile devices. In the method, the data is processed from an initiating mobile device to a terminating mobile device by passing through at least one other mobile device that is in a standby mode. System and computer program products which can execute a method of the invention are also provided.

### BACKGROUND OF THE INVENTION

Many different types of portable and non-portable wireless communications devices are designed to communicate with telecommunications systems. These wireless communications devices are used to provide various forms of communication across various telecommunication systems. These wireless communications devices may include mobile phones, pagers, and laptops with integrated radio communications. Examples of the various forms of communication include electronic mail, file transfer, web browsing, and other exchange of digital data including audio (e.g., voice) and multimedia (e.g., audio and video).

Wireless mobile phone systems are communication devices that are primarily in a standby mode waiting to receive a phone call or to execute a function or command. Typically, a wireless cellular telephone user keeps the cell phone on waiting to receive a phone call or until the user dials a phone number. During the time the cell phone is in standby mode, it consumes battery power but does not perform any useful functions.

Wireless mobile phone systems can be used with all types of telecommunication systems, including, for example, an Integrated Systems Digital Network (ISDN), a Voice over IP (VoIP) network, the Internet, or mobile telephony networks, such as those based on Time Division Multiple Access (TDMA), Global System for Mobile communication (GSM), Code Division Multiple Access (CDMA), Time Division Synchronous Code Division Multiple Access (TD-SCDMA), Integrated Digital Enhanced Network (iDEN), a General Packet Radio Service (GPRS) network, or a Universal Mobile Telecommunications System (UMTS) network, and the next generation of wireless technologies for wireless data services and applications, such as wireless email, web, digital picture taking/sending and assisted-GPS position location applications, and compatible network protocols, such as hyper text transfer protocols (HTTP), file transfer protocols (FTP), VoIP protocols, and UMTS protocols as defined by 3GPP group (see http://www.3gpp.org). However, for the sake of simplicity, discussions will concentrate mainly on exemplary use of a UMTS mobile network and cellular phones, although the scope of the present invention is not limited thereto.

The UMTS covers a geographical area that is subdivided further into cells or regions. A cell generally includes a base station, also known as a Node B, and numerous types of mobile equipment or cellular phones. Multiple base stations are controlled by a radio network controller. The UMTS generally provides a channel on which all the cellular phones can measure signal strength and quality and receive system information from the base stations.

In wireless communication systems, maintaining a high quality link is important. Generally the cellular phone uses the shortest possible distance to a base station in addition to measurements to maintain the highest quality link. However, as a cellular phone moves in the geographical region, the cellular phone may be moved to a location closer to another base station. In order to maintain the highest quality and strength signal, the cellular phone and the base station that was initially supporting the call will switch to another base station in the UMTS to provide coverage in another cell. The process of switching base stations during a call or data transmission is referred to as a handover operation or handoff. Unfortunately, when the signal has degraded with the present base station there may not be a new base station with a better signal available to switch to, or the new base station may be at capacity and unwilling or unable to accept new calls.

As the cellular phone moves around when the power is on but the phone is not being used for a call or data transmission, the cellular phone is in a standby mode. Even during this standby mode, the cellular phones engage in handover operations as the user moves around without the user being aware such actions are occurring.

Today, the distribution of cellular phones that are in standby mode in metropolitan areas is very large and dense. However, presently no use is made of the abundant cellular phones that are sitting and waiting in silence. Accordingly, it is important to use the bandwidths of the available communications devices, which are not being actively used, to improve signal quality for other users and to increase an available data transmission capacity. Accordingly, it is desirable to permit these silent cellular phones to serve as mobile base stations for each other in order to provide better coverage and data transmission capacity.

### SUMMARY

Various aspects and example embodiments of the present invention advantageously provide utilizing the ubiquitous mobile devices that are capable of receiving and transmitting data of all forms while being in standby mode in a secure and non-intrusive way to provide greater coverage and bandwidth to the telecommunications network. The mobile devices such as cellular phones can be configured to receive and send from and to each other and/or base stations all types of cellular traffic that represents different sources of origin (i.e., audio, video, data files, etc.).

In accordance with an aspect of the present invention, a method of processing silent handover requests in a mobile device within a cell controlled by a base station of a mobile telecommunications network, comprising: receiving a handover request from an originating mobile device, determining whether the mobile device is in a standby mode, transmitting an acknowledgement signal to the originating mobile device when the mobile device is determined to be in the standby mode, and establishing a silent communications link for data transfer with the originating mobile device.

In accordance with aspects of the present invention, the mobile devices having a silent communications enabled function will keep a real time handover table that includes a predefined number (n) of similar silent communications enabled mobile devices that are nearby and in silent mode in the mobile devices respective memories. When the mobile device is being used by its user, the mobile device will handover its silent communications to the first available silent communications enabled mobile device available in its handover table. The handover may also occur as a result of the current power level of the battery of the silent communications enabled mobile device dropping below a predetermined level.

If no silent communications enabled mobile devices are available in the handover table, the current silent communications enabled mobile device when it needs to handover its communications, will send a flag to the sending source that is unable to handover and therefore it will be up to the sending source to find an alternative silent communications enabled mobile devices. This process of flagging back the inability of handover may be repeated up to predefined (m) times after which the sending source has to send its incoming data streams to a silent buffering server of a base station. The silent buffering server will look for silent communications enabled mobile devices that become available to stream to its buffered data.

According to another aspect of the present invention, a method of initializing mobile devices having silent chips enabling silent communications transmissions during standby mode using handover requests in a mobile telecommunications network, comprising: transmitting an initialization signal from each of the mobile devices to a corresponding base station, the initialization signal comprising identifying information of each of the mobile devices; receiving a tailored handover table for each of the mobile devices comprising a set of identifying information corresponding to the remaining mobile devices selected by the corresponding base station; and entering the standby mode for each of the mobile devices after receiving the tailored neighboring list from the corresponding base station.

In accordance with another aspect of the present invention, a telecommunications system, comprising: mobile devices each configured to process data communications for other mobile devices when in a standby mode; a base station controlling the data communications for the mobile devices within a cell of the telecommunications system; and at least one silent buffering server to generate a master list of identifying information of all the mobile devices in the cell and to generate a tailored list for each of the mobile devices comprising a selected set of the identifying information of nearby ones of the other mobile devices, wherein each of the mobile devices is configured: to receive from the base station the tailored list; to transmit a handover request to a first one of the other mobile devices on the tailored list when the data communications are being processed; and to establish a silent communications link for the data communications with the first one of the other mobile devices if the first one of the other mobile devices is in a standby mode.

In accordance with yet another aspect of the present invention, a computer readable medium having stored thereon a plurality of instructions which, when executed by a mobile device in a wireless telecommunications network having at least one base station and associated other mobile devices, cause the mobile device to perform the steps of: transmitting an initialization signal to the base station; receiving a tailored neighboring list from the base station comprising a selected set of the associated other mobile devices that are nearest the mobile device; and entering a standby mode after receiving the tailored neighboring list.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 illustrates an example mobile telephony network including a plurality of silent chip cellular phones according to an embodiment of the present invention;

FIG. 2 is a flowchart of initializing the silent chip cellular phone according to an embodiment of the present invention;

FIG. 3 is an example silent handover table according to an embodiment of the present invention;

FIG. 4 illustrates a base station gathering and distributing neighbor lists to the silent chip cellular phones according to an embodiment of the present invention;

FIG. 5 illustrates a method of silent handover using the silent chip cellular phones according to an embodiment of the present invention;

FIGS. 6A-6B show a flowchart of a method of an silent chip cellular phone processing silent handovers according to an embodiment of the present invention;

FIG. 7 illustrates an alternative method of an silent chip cellular phone gathering a handover table of other silent chip cellular phones; and

FIG. 8 is a block diagram of the silent chip cellular phone according to an embodiment of the present invention.

### DETAILED DESCRIPTION OF THE EMBODIMENTS

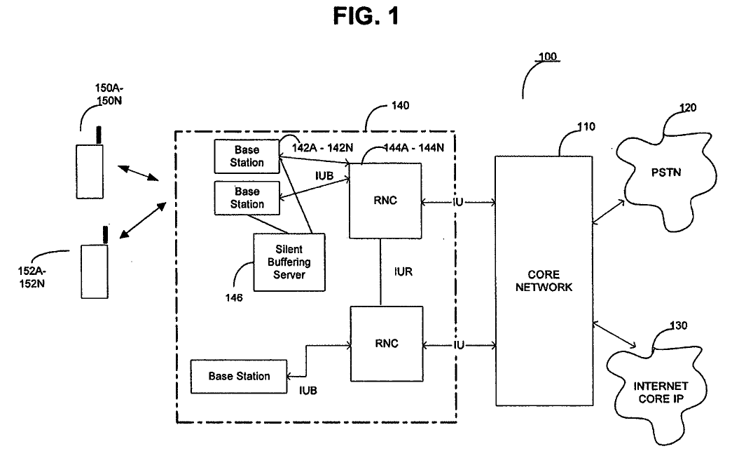

Attention now is directed to the drawings and particularly to FIG. 1, in which an example of a mobile telephony network, such as a universal mobile telecommunications system (UMTS) network in which an embodiment of the present invention may be used is illustrated. As shown in FIG. 1, the mobile telephony network 100 includes a core network 110 which supports circuit-switched networks such as a public switch telephone network (PSTN) 120, and/or packet-switched networks such as Internet 130; a radio access network 140 connected to the core network 110 to support communications with a user equipment (UE) 150A-150N and 152A-152N which are typically a cellular phone, a video phone or a personal digital assistant (PDA). According to aspects of the present invention, a portion of the user equipment in a cell should be the UEs 150A-150N that are silent chip enabled. Being silent chip enabled refers to the UE 150A-150N being able to process handoffs to other neighboring silent chip UEs 150A-150N when in a silent mode such that the silent chip UEs 150A-150N may function as mobile base stations. Silent as used in this application refers to the mobile device communicating data while the user of the mobile device is unaware that the data communications are flowing through the mobile device. The silent chip enabled UEs 150A-150N will also be able to process data communications between two nodes in the telecommunications system. The remaining portion of UEs 152A-152N in the cell may be conventional cellular phones or other types of mobile equipment. The UEs, both silent chip and conventional, may be cellular phones, a laptop computer, a hand-held computer, a Palm-sized computer, a PDA or any other mobile computing platform that is able to communicate using a wireless communication. The administration of the silent chip UE 150A-150N by a particular base station 142A-142N will provide the ability of the silent chip UE 150A-150N to display (while in silent mode, i.e. in standby mode) its geographical location with accuracy within the maximum diameter of the coverage area of the base station 142A-142N.

Typically, the core network 110 contains a mobile switching center (MSC) (not separately shown) supporting communications in the system, via the circuit switched network such as PSTN 120, and one or more support nodes (not shown) providing a gateway to the packet-switched network such as the Internet 130 and controlling the connection between the network and the user equipment (UE) 150A-150N and 152A-152N for wireless communications. The radio access network 140 includes one or more Node “B's”, also known as base stations, 142A-142N, and one or more radio network controllers (RNCs) 144A-144N connected to the localized group of Node B's 142A-142N to select the most appropriate node for the user equipment (UE) 150A-150N and 152A-152N and perform handover during wireless communications, when necessary. Network architecture and implementation of the mobile telephony network 100, as shown in FIG. 1, including backbone ATM switches, interfaces such as “lu” disposed between the RNCs 144A-144N and the core network 110, “lur” disposed between the RNCs 144A-144N, “lub” disposed between the RNCs 144A-144N and the corresponding base stations 142A-142N, signaling links between nodes and network elements within the mobile telephony network 100, and signaling information passing between the signaling links are well-known and, as a result, need not be described in detail herein.

Additionally, each base station 142A-142N according to aspects of the present invention includes a silent backup server (SBS) 146. The SBS 146 may be any computer system or microprocessor based system, such as a UNIX workstation or a WINDOWS based computer system. The SBS 146 will need either internal or external storage of a sufficient size to store all the identifying information for the silent chip UEs 150A-150N in the cell. As will be described in more detail below, the SBS 146 will create a neighbor list or silent table for each silent chip UE 150A-150N in a cell served by that particular base station 142A-142N. The SBS 146 will also generate and maintain a complete list of the entire silent chip UEs 150A-150N within the cell. The SBS 146 will update the list as Silent chip UEs 150A-150N enter or leave the cell. Alternatively, it is possible that a single SBS 146 could serve several base stations.

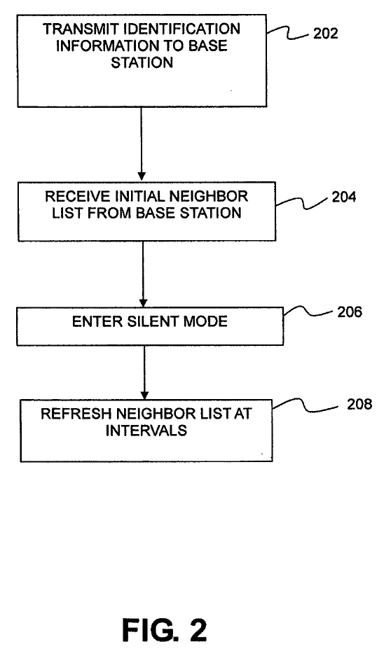

FIG. 2 is a flowchart of the initialization process of a silent chip UE 150A-150N according to an embodiment of the present invention. In operation 202 an initial UE 150A-150N transmits identifying information to the closest base station 142A-142N identified by measuring signal strength and/or quality on, for example, a broadcast channel. The transmission of the identifying information occurs when the silent chip UE 150A-150N is first turned on or when the silent chip UE 150A-150N has power and enters a new cell area while moving. The identifying information includes at least the following information: OP Code=Operation code that identifies the originating switch/STP, etc.; CIC=Circuit Identification Code for the originating caller; OPC=Originating Point Code, which is the code that identifies the calling party that has used the silent service until a handover to another silent chip UE 150A-150N is to be made; DPC=Destination Point Code, which is the code that identifies the called party with the connected original caller. Other wireless identification parameters such as a silent chip UE 150A-150N ID, phone number, silent chip model and firmware number, the last base station which the current silent chip UE 150A-150N was communicating with, a current handover table table, the last usage time, the last handover serviced, the last handover requested and identity of its current base station and the silent backup server associated with it may also be transmitted as additional identifying information depending on the state of the silent chip UE 150A-150N being initialized. This enables the silent chip UE 150A-150N to know where to go next, should communication be lost during transmissions with another silent chip UE 150A-150N.

The base station 142A-142N receives the identifying information and the SBS 146 stores the information for that initial silent chip UE 150A-150N. Each SBS 146 creates a master neighbor candidates list of the entire silent chip UEs in its respective cell. The SBS 146 then compiles a handover table of a predetermined number of other silent chip UEs 150A-150N that are near the initial silent chip UE 150A-150N from the master neighbor candidates list and transmits the handover table to the initial silent chip UE 150A-150N. The handover table includes identifying information of the nearby predetermined number of other silent chip UEs 150A-150N so that the initial silent chip UE 150A-150N will be able to establish a communication link with the silent chip UEs 150A-150N on its handover table. In operation 204 the silent chip UE 150A-150N receives and stores the handover table transmitted from the SBS 146 via the controlling base station 142A-142N. The silent chip UE 150A-150N then enters a silent mode or S-mode in operation 206. This refers to the silent chip UE 150A-150N actively listening for signals from a base station or other silent chip UEs 150A-150N. In operation 208, the silent chip UE 150A-150N periodically refreshes its neighbor list by requesting a new list or an updated list from the SBS 146 via the base station 142A-142N controlling that particular cell. The updates may include updates or replacements to the handover tables, handover service requests, real time stream data, acknowledgements or negative acknowledgements from other silent chip UEs, identifiers of silent chip UEs newly joining the cell, or any combination thereof. Generally, these updates will occur quite frequently due to the dynamic nature of mobile equipment within a cell, for example, every five minutes. Communication between the silent chip UE 150A-150N and the base station 142A-142N may be carried out over a conventional broadcast channel such as a Broadcast Control Channel in the mobile telephony network 100.

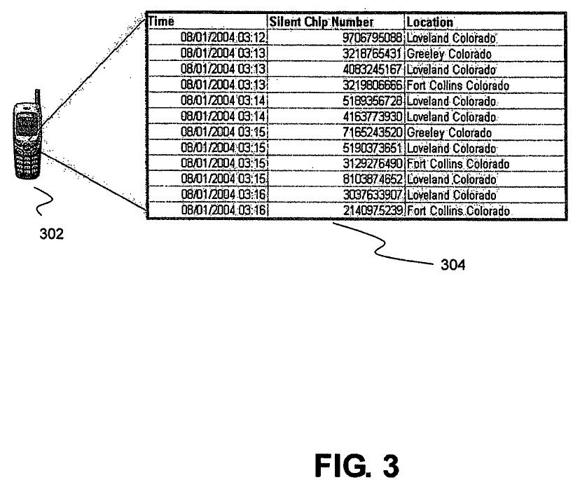

FIG. 3 shows an example of a silent chip UE 302 handover table 304. The handover table 304 may be, for example, a list of one hundred other silent chip UEs within the same cell as the silent chip UE 302 near the silent chip UE's 302 location, and is initially assigned by the corresponding base station. Only twelve abbreviated entries of the handover table 304 are illustrated for clarity. The entries show the time, the silent chip number and corresponding location. For example, the first entry corresponding to a nearby silent chip UE shows that the entry was made at 3:12 on Aug. 1, 2004, that the ID of the silent chip UE is 9706795088 and that presently that silent chip UE is in Loveland, Colo. Also, the shown handover table 304 does not depict all of the identifying information stored. Because the initial silent chip UE 302 received the identities of the other silent chip UEs (i.e., the identifying information such as the silent chip number) in the nearby geographical area within the cell, the initial silent chip UE 150 can establish links with any of the other silent chip UEs on its handover table 304 via a broadcast channel or beacon signaling.

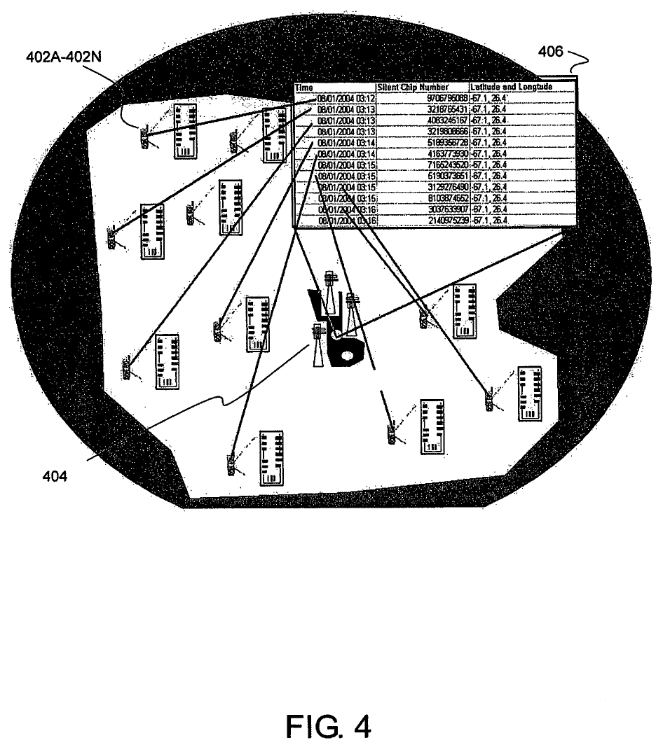

FIG. 4 illustrates a silent buffering server (146 in FIG. 1) via a base station 404 gathering and distributing handover table entries which may be formed into a master handover table 406. A group of silent chip UEs 402A-402N will be administered in real time by the SBS 146 associated with the base station 404 so that an accurate up to date list of all the silent chip UEs 402A-402N within the cell covered by the base station 404 is maintained. The number of these silent chip UEs 402A-402N will depend on the bandwidth of the base station 404 and the geographical contour around the base station 404. The silent buffering server (SBS) will then generate and distribute individually configured handover tables to each of the silent chip UEs 402A-402N from the master handover table 406 according to an embodiment of the present invention. In order to generate an individually configured handover table, the SBS 146 compiles together a predetermined number of the other silent chip UEs that are the closest to the silent chip UE that is being initialized.

As shown in the diagram, the base station 404 receives transmissions from a plurality of silent chip UEs 402A-402N in a cell region and forms a master handover table 406 of the identifying information of all the silent chip UEs in the cell region such that individual handover tables may be generated for each silent chip UE 402A-402N based on the proximity of the other silent chip UEs 402A-402N with the silent chip UE 402A-402N being assigned the handover table. The SBS at the base station 404 stores the identifying information and forms a handover table 406 for transmission to a particular silent chip UE 402A-402N in the cell region. When a silent chip UE 402A-402N is mobile, it will be transferred from one base station 404 to another if it is leaving a domain or cell region of the base station 404 to another cell region. When the silent chip UE 402A-402N transfers to another base station, the other base station will then generate a new handover table for the silent chip UE 402A-402N that just entered its cell region pursuant to the initialization process described with respect to FIG. 2.

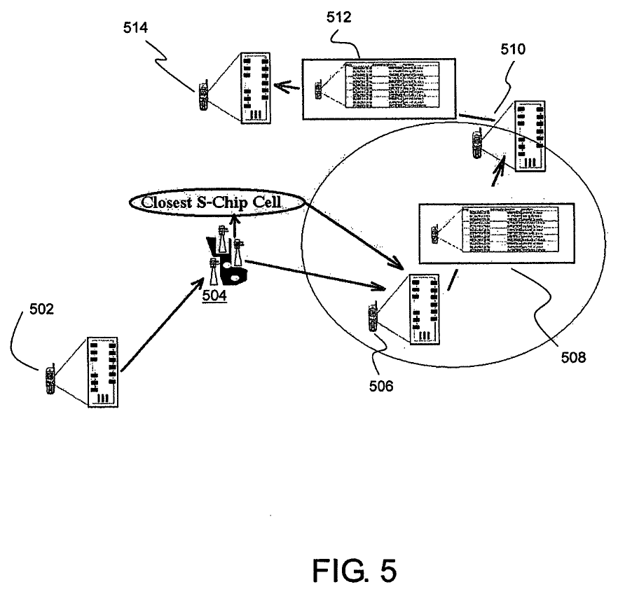

FIG. 5 illustrates a method of processing silent handover requests using the silent chip UEs as used in a mobile telephony network according to an embodiment of the present invention. The source UE 502, which may be either a conventional cellular phone or a silent chip UE, initiates a call to a destination UE 514, which in this example is a silent chip UE though it is not necessarily limited to such. The source UE 502 establishes a link in a conventional manner with the base station 504 for the data transmission. The SBS (not separately shown in FIG. 5) for the base station 504 finds the closest silent chip UE 506 to the base station 504 and performs a handover operation for the data transmission in order to handoff responsibility for the communication to adjust capacity.

The silent chip UE 506 pulls the first entry from its handover table 508 and through a broadcast channel sends a signal to establish a link to the silent chip UE 510 corresponding to the first entry. The silent chip UE 510 checks the destination in the identifying information transmitted with the data by the silent chip UE 506 and determines that the destination UE 514 is in range and sends a signal to establish a link with the destination UE 514. Once this chain is linked, a tunnel or trunk is established between the source UE 502 and the destination UE 514 and data communication is carried out. In this manner the data communication is routed to the destination from the source. The data may be voice, text, audio, video or other form of data.

As an alternative, if the source UE 502 is a silent chip UE, then the base station 504 may be skipped and a handover process may be initiated directly with another silent chip UE. This may be desirable where the signal from the source UE 502 to the base station 504 is weak and a stronger signal may be obtained by first performing a handover process with a nearby silent chip UE that may have a better signal. Also, if the base station 504 is at or near capacity it may not be accepting additional calls, and instead of waiting the source UE 502 will automatically search for a nearby silent chip UE to pass the communications to through the handover process.

For example, if the silent chip source UE 502 has been initialized then it may handover communication to another silent chip UE on its handover table. Thus, a silent communication link would be established with silent chip UE 506 rather than the base station 504 as the first operation executed by the source UE 502. Such a link is also beneficial if the base station 504 is at capacity and unable to process additional calls. When the source and destination are located far apart geographically, then the source UE 502 would establish a link with the base station 504 first that would pass the data communication to another base station located near the destination in the telecommunications system 100. The delay associated with buffering due to inability to silent handover may have a predefined maximum limit that disqualify a particular type of data (like voice representation) from continuing in the silent communications mode.

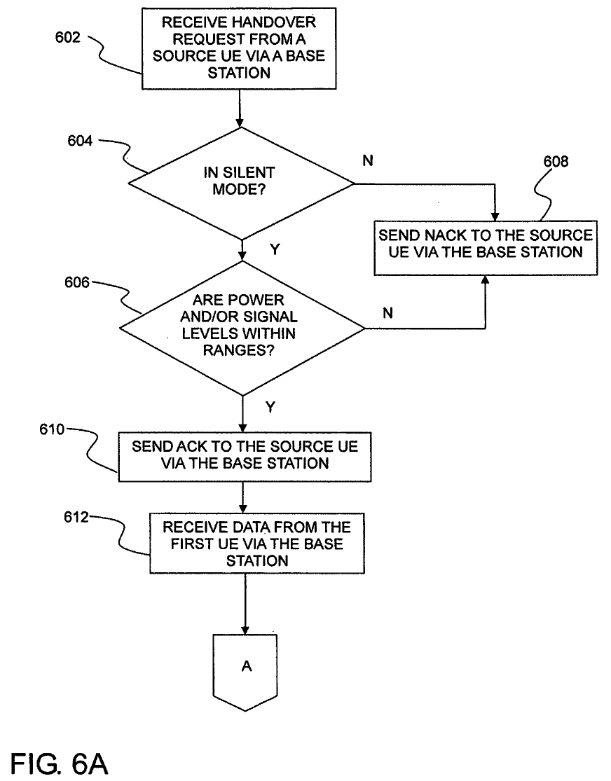

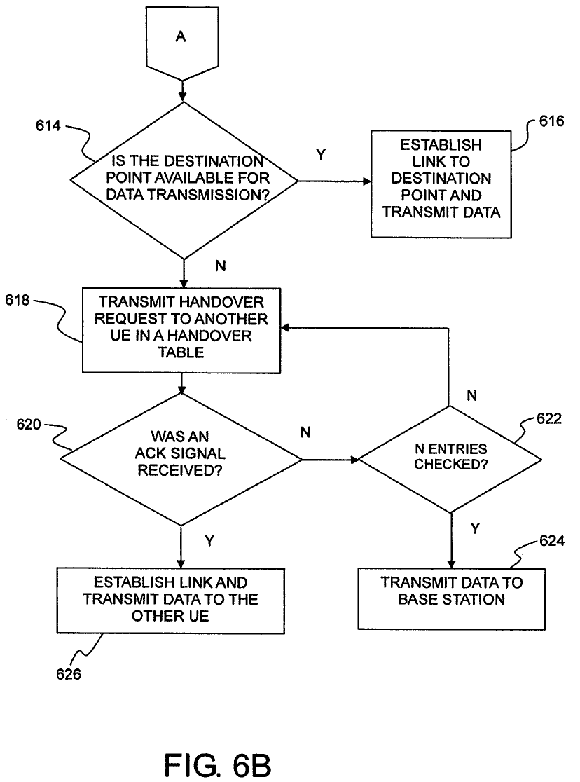

FIGS. 6A-6B show a flowchart of a method of processing silent handovers via silent chip UEs according to an embodiment of the present invention. In operation 602, the silent chip UE 506 receives a handover request from base station 504. In operation 604, the silent chip UE 506 checks to see if it is in the silent mode that was set up as described in operation 206 of FIG. 2. If the silent chip UE 506 is in the silent mode, then the silent chip UE 506 checks whether its power level and signal strength are within set operational ranges in operation 606. In operation 608, if the silent chip UE 506 is not in silent mode or if either the power level or signal strength are not within the operational ranges then the silent chip UE 506 transmits a negative acknowledgement (NACK) signal to the base station 504. Though the handover request is shown and described as coming from the base station 504, it is to be understood that the handover request may be from another silent chip UE. For example, if described from the perspective of silent chip UE 508, then the handover request would come from silent chip UE 506.

If the silent chip UE 506 is in the silent mode and has suitable power level and/or signal strength, then the silent chip UE 506 sends an acknowledgement signal (ACK) signal to the base station 504. Once the ACK signal is received by the base station 504, a link is established between the base station 504 and the silent chip UE 506 for data transmission in operation 612. Once the link is established communications between the base station and the silent chip UE 506 are handled in a conventional manner.

In operation 614, the silent chip UE 506 checks the identifying information transmitted from the base station 504 and checks if the destination silent chip UE 514 is available. If the destination UE 514 is within range of the silent chip UE 506 then a link is established to the destination UE 514 in operation 616 and a tunnel or trunk is set up between the originating UE 502 and the destination UE 514. If the destination UE 514 is not available or not within range then in operation 618 the silent chip UE 506 transmits a handover request to the first entry in its handover table 508. The silent chip UE 506 checks for receipt from the first entry an acknowledgement (ACK) or a negative acknowledgement (NACK) signal in operation 620. The NACK signal may also be triggered by an event such as when the silent chip UE 510 corresponding to the first entry is not available, out of range, turned off, or presently in use. If the ACK signal is received then the silent chip UE 506 establishes a link and proceeds to transmit data including all necessary identifying data to the first entry silent chip UE 510 in operation 626. Because the identifying information includes the source and destination, the call is eventually routed to the destination. If the NACK signal is received then the silent chip UE 506 determines if it has attempted the handover process with a predetermined number of different entries, such as ten, in the handover table 508 in operation 622. If the silent chip UE 506 has not tried to unsuccessfully establish a connection with the predetermined number of different entries in the handover table 508 then the silent chip UE 506 tries to establish a handover with the next entry in the handover table 508. This process repeats until a handover is successfully performed or the predetermined number of different entries is reached. In operation 624, if the silent chip UE 506 was unsuccessful the predetermined number of times at establishing a link with any of the handover table silent chips and performing handover then a NACK is sent to the base station 504. The base station 504 then can process the data transmission by either transmitting the data to the destination UE 514 or by performing a handover operation to another silent chip UE or in a conventional manner directly to the destination UE. Such a decision may depend, for example, on whether the base station is operating near capacity or if it is unable to establish a clear signal with the destination UE within its cell.

During operation of any of the silent chip UEs an additional handover may need to be initiated if a user is going to use the silent chip UE to make a call, send data, if power drops below the operational range, etc. When the user initiates an action on the silent chip UE, the silent chip UE will proceed directly to operations 618 through operation 624. Alternatively, the silent chip UE may use a flag back process to indicate that a handover of the current communications needs to be made. The silent chip UE, after unsuccessfully attempting a predetermined number of times to handover communication to another silent chip UE, will send a flag back to whatever source that the silent chip UE is receiving data from. The source, either the base station or some other silent chip, will then be notified that an alternative silent chip UE must be found to take over for the silent chip UE dropping from the tunnel or trunk. The source may then use a process as set forth in operations 618 through operation 624 to attempt to locate another silent chip UE. If the source is not a base station then after a predetermined number of times the base station controlling that cell will be tasked with responsibility for processing the communication.

A user is completely unaware when the user's silent chip UE is being utilized to process data communications according to the silent communication method discussed above with respect to FIGS. 5 and 6. In order to provide further privacy, the data communications may be encrypted. However, because of the operation of the silent chip UE such encryption would not be required. When a user begins to execute a command or interact with the user's silent chip UE, a process is begun to immediately hand off any communications that the silent chip UE is presently supporting to another silent chip UE or a base station so that it is not in the communications tunnel any more. Thus, the user will not be aware when the user's silent chip UE is passing data and will be unable to interact or view the data passing through the silent chip UE. Because of the possibility of quick or frequent hand offs due to required transfers the silent communications a buffer may be used to store a portion of any data communications so that the call initiator and receiver will not notice any interruptions or breaks in service.

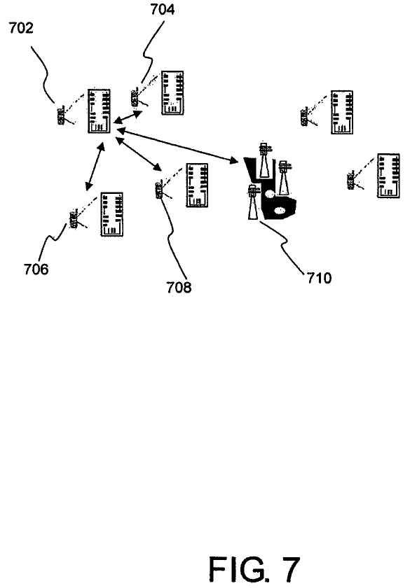

FIG. 7 illustrates an alternative method of a silent chip cellular phone gathering a handover table of other silent chip cellular phones. Referring to FIG. 7, a first silent chip UE 702 may be initialized by establishing communication links with nearby silent chip UEs that are close enough to receive the broadcast. The first silent chip UE 702 sends out an initializing message on the broadcast channel that a second silent chip UE 704, a third silent chip UE 706, and a fourth silent chip UE 708 are within range to receive and respond. Upon receiving the initializing message, which includes the identifying information corresponding to the first silent chip UE 702, the second silent chip UE 704, the third silent chip UE 706 and the fourth silent chip UE 708 respond with each of its respective identifying information. The first silent chip UE 702 stores the received identifying information in a table to form the handover table. Each of the second silent chip UE 704, the third silent chip UE 706 and the fourth silent chip UE 708 adds the received information from the first silent chip UE 702 to its respective corresponding handover table. In this manner each silent chip UE may accumulate its own handover table without having to rely on the base station 710. The signaling can then be carried out periodically to update the handover table. However, each silent chip UE may also receive updates to the handover table from the base station 710 at periodic intervals. Alternatively, the silent chip UE may receive an initial handover table from the base station upon power up or movement into a new cell as described above with respect to FIG. 2 and update the handover table by signaling with nearby silent chip UEs so that base station resources are not continually being used.

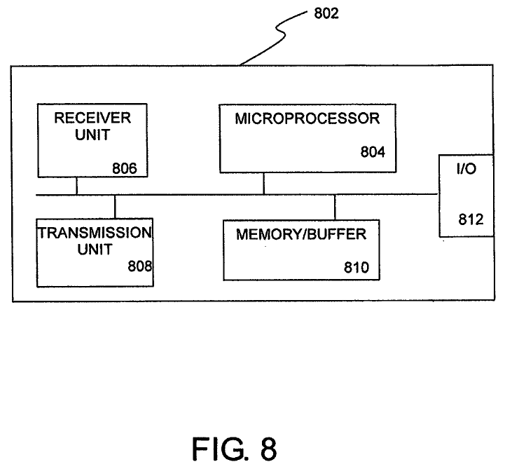

FIG. 8 is a block diagram of the silent chip UE according to an embodiment of the present invention. The silent chip UE 802 comprises a microprocessor 804, a receive unit 806, a transmission unit 808, a memory/buffer 810, and an input/output (I/O) unit 812 connected through a bus. Other components of the silent chip UE 802 are similar to those found in conventional cellular phones and are not described in detail. The memory/buffer 810 comprises a buffer and a dynamic cyclic buffer. The dynamic cyclic buffer stores the handover table generated by either the base station or the silent chip UE 802. The dynamic cyclic buffer rolls data through and the most recent entry pushes out the oldest entry. The buffer is used to ensure seamless connections so that if a handover needs to be made because of an occurrence such as the silent chip UE 802 being placed in use. This prevents the caller from noticing a data gap or choppy transmission. When the silent chip UE 802 receives an update from a base station as discussed above with respect to operation 208, only a number of entries which need to be added are accepted and entered into the dynamic cyclic buffer by the microprocessor 704. For example, if 2 of the 100 neighboring silent chip UEs are out of service, out of power, have a bad signal, etc. then when the silent chip UE 802 receives an update from the base station it may either take 2 of the entries for the dynamic cyclic buffer and disregard the rest or replace the entire handover table. Some of the information that is stored in the dynamic cyclic buffer comprises handover table entries, statistical information such as the last serviced handover, the last requested handover, the last usage time, the last base station and the expected time in service or any combination thereof. The receive unit 806 communicates with the base station and with other silent chip UEs under control of the microprocessor 804. The transmission unit 808 also communicates with the base station and with the other silent chip UEs under control of the microprocessor 804. The transmission unit 808 and the receive unit 806 may use a broadcast channel or may send out signaling beacons to other UEs in the vicinity in order to establish silent communication links. The silent chip UE will keep real time handover table that includes a predefined number (n, where n is a whole number) of similar silent chips in their respective silent chip UEs that are nearby and in silent mode as well. When the silent chip UE is being used by its user, the silent chip UE will handover its silent communications (i.e., communications occurring when the silent chip UE is in S-mode) to the first available silent chip UE available in its handover table. The handover may also occur as a result of the current power level of the silent chip battery goes below a certain level that practically shuts off the cell phone. The silent chip will keep real time handover table that includes a predefined number (n) of similar silent chips in their respective cell phones that are nearby and in silent mode as well. When the cell phone is being used by it user, the silent chip UE will handover its silent communications to the first available silent chip UE available in its handover table. The handover may also occur as a result of the current power level of the silent chip battery dropping below a certain level that practically shuts off the cell phone and/or the current signal level drops out of an acceptable range. The power level threshold may also be set so that the user will still have usable battery capacity for normal functions when the Silent chip UE stops accepting handover responsibility.

The untapped dissipating energy in the ubiquitous silent cellular phones according to aspects of this invention will be used wisely in a secured mode of operation and will not affect the normal usage of the cell phones because of the silent handover protocol that commissions the optimal usage of these phones during standby.

As an example of a call being made and processed in the system according to aspects of the present invention will be described. The example will be described using cell phones as the user equipment (UE). Assuming the cell phone with the current silent chip is S1, the target of the handover to be cell phone with silent chip is S2 and the handover requester silent chip UE is S3. The base station includes a silent backup server (SBS) and the maximum number of handover iterations permitted to be attempted by the current silent chip cell phone S1 to the handover to be silent chip cell phone S2 is M, where M is a whole number. The maximum number of attempts to request silent service communication by the SBS to the silent chip cell phone S2 is N, where N is a whole number. The maximum number of entries of the Handover Table is Stmax.

First, the silent chip cell phone S1 is powered on. Upon power up, the silent chip cell phone S1 transmits to the SBS at the base station its identification parameters as shown in Table 1.

TABLE 1

Cell Phone Number
Silent Chip Model Number
Current Handover Table
Last Usage Time
Last Handover Serviced
Last Handover Requested
Silent Chip Firmware Version

The silent chip cell phone S1, in response to its transmission, receives from the SBS at the base station its Handover Table entries for the cell administered by the base station up to Stmax. At periodic intervals, the silent chip cell phone S1 receives from the SBS at the base station updates that include parameters as shown in Table 2:

TABLE 2

Handover Table Entries
Handover Service Requests
Real Time Stream Data
ACKs and/or NACKs from other silent chip enabled cell phones
IDs of newly joining silent chip enabled cell phones

The silent chip cell phone S1 saves the information received from the base station in its dynamic cyclic buffer, such as the buffer 810 in FIG. 8. The silent chip cell phone S1 also saves statistical information such as the last serviced handover, last requested handover, last usage time, last base station and expected time in service in the dynamic cyclic buffer.

After initialization then the silent chip cell phone S1 goes into silent mode (i.e., standby) until the cell phone is either used or requested to perform a handover communication.

When the user makes or receives a phone call, the silent chip cell phone S1 goes through the handover process with the base station to service the current call in an ordinary manner. The base station may then utilize the handover communications described above to use other silent chip enabled cell phones to route the call.

When the silent chip cell phone S1 receives a handover request from the silent chip cell phone S3, the silent chip cell phone S1 services this request in the silent mode. The silent chip cell phone S1 receives and transmits all wireless communication data between two calling parties (i.e., two of its end points). The silent chip cell phone S1 makes a handover request to the silent chip cell phone S2 if either its power reaches a minimum predefined level or its user makes or receives a phone call while it was serving a call in the silent mode. If the handover request to the silent chip cell phone S2 fails, the silent chip cell phone S1 repeats the handover request to different silent chip cell phones in its handover table up to M times. If the handover requests fail for each of the M entries in the handover table table, then the silent chip cell phone S1 advises the SBS in the base station.

The SBS in the base station then makes a handover request to the silent chip cell phones in its reachable domain, or cell, one at a time. If the handover request by the SBS to some silent chip cell phone is successful, then the process for handling the current handover request is complete. However, if the SBS tries unsuccessfully up to N times then the current handover request will be denied and a negative acknowledgement (NACK) signal should be sent to the original handover requesting silent chip cell phone S3.

According to aspects of the present invention, when a silent chip cell phone receives a handover request that it is capable of serving it proceeds to send an acknowledgement (ACK) message to the requesting silent chip cell phone or the SBS associated with the base station. The recipient silent chip cell phone will service the silent call (i.e., a flow through communication not involving the user of the recipient silent chip cell phone) and transmits all of its wireless communications. The recipient silent chip cell phone transmits to the SBS its ID information that includes the last serviced silent call.

According to aspects of the present invention, the ubiquitous mobile devices are modified to have the unused capabilities of receiving and transmitting data of all forms while being in standby mode by a method that is capable of handling these communications in a secure and non-intrusive way.

According to aspects of the present invention, cellular phones with a new functionality can receive and send from and to each other and/or base stations all types of cellular traffic that represents different sources of origin (i.e., audio, video, data files, etc.) in order to automatically compensate for a base station at capacity or poor signal strength.

The method of silent handover communication can be software modules written, via a variety of software languages, including C, C++, Java, Visual Basic, and many others. The various software modules may also be integrated in a single application executed on one or more control units (not shown), such as a microprocessor, a microcontroller, or a processor card (including one or more microprocessors or microcontrollers) in the silent chip UE 802, for example, as shown in FIG. 8. Also, the software modules can also be distributed in different applications executed by different computing systems in addition to the various types of user equipment, such as the base station 142A-142N connected to the mobile telephony network 100, as shown in FIG. 1. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs).

Instructions of the software routines or modules may also be loaded or transported into the user equipment 150A-150N, the silent backup server in the base station 142A-142N or any computing devices or combinations thereof on the mobile telephony network 100 in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof.

For example, the instructions of the software routines may be downloaded to the user equipment 150A-150N as a firmware upgrade to perform the functions as described. In addition, the wireless network has been described in the context of a telecommunications network having an architecture typical of North America, it should be appreciated that the present invention is not limited to this particular wireless network or protocol. Rather, the invention is applicable to other wireless networks and compatible communication protocols. Furthermore, alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. Lastly, the methods as described in connection with FIGS. 2-7 can also be machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Accordingly, it is intended, therefore, that the present invention not be limited to the various example embodiments disclosed, but that the present invention includes all embodiments falling within the scope of the appended claims.

What is claimed is:

1. A method of processing silent handover requests in a mobile device within a cell controlled by a base station of a mobile telecommunications network, comprising:
receiving a handover request from an originating mobile device;
determining whether the mobile device is in a standby mode;
transmitting an acknowledgement signal to the originating mobile device when the mobile device is determined to be in the standby mode; and
establishing a silent communications link for data transfer with the originating mobile device.

2. The method of claim 1, further comprising:
transmitting another handover request to another mobile device;
establishing another silent communications link for the data transfer between the originating mobile device and the other mobile device via the mobile device if another acknowledgement signal is received from the other mobile device, wherein identifying information corresponding to the other mobile device is an entry in a handover table stored in the mobile device.

3. The method of claim 1, further comprising:
receiving a handover table from the base station comprising identifying information corresponding to different mobile devices near the mobile device;
transmitting different handover requests to the different mobile devices using the identifying information in the handover table until another acknowledgement signal is received from one of the different mobile devices in response indicating that the one of the different mobile devices is in the standby mode; and
establishing the silent communications link for the data transfer between the originating mobile device and the one of the different mobile devices via the mobile device.

4. The method of claim 3, further comprising:
transmitting a new handover request to the base station in the cell of the telecommunications network after the transmitting the different handover requests to a predetermined number of the different mobile devices and the other acknowledgement signal is not received; and
passing the silent communications link for the data transfer to the base station, wherein the base station takes over the data transfer with the originating mobile device.

5. The method of claim 1, further comprising:
broadcasting another handover request to nearby mobile devices if a user begins using the mobile device;
receiving an acknowledgement signal from at least one of the nearby mobile devices that is in standby mode; and
handing over the silent communications link for the data transfer between the originating mobile device and the mobile device to the at least one of the nearby mobile devices and the originating mobile device when the acknowledgement signal is received.

6. The method of claim 1, further comprising:
generating a master handover table comprising identifying information corresponding to a plurality of mobile devices within the cell including the mobile device;
generating a handover table by selectively picking entries from the master handover table that are near the mobile device; and
transmitting from the base station to the mobile device the generated handover table.

7. The method of claim 1, further comprising:
broadcasting an initialization signal capable of reception by nearby mobile devices;
receiving response signals including identifying information from the nearby mobile devices; and
generating a handover table comprising the identifying information corresponding to the nearby mobile devices by storing the received responses in the mobile device.

8. The method of claim 7, wherein the initialization signal comprises information corresponding to the mobile device including an operation code, a circuit identification code, an originating point code and a destination point code.

9. The method of claim 7, wherein the identifying information comprises a predetermined combination including an operation code, a circuit identification code, an originating point code, a destination point code, a unique silent chip identifier number, phone number, silent chip model and firmware number, a last base station which the mobile device was communicating with, a current neighboring list table, a last usage time, a last handover serviced, a last handover requested or an identity of the corresponding base station.

10. The method of claim 7, further comprising:
transmitting different handover requests to the nearby mobile devices using the identifying information in the handover table until another acknowledgement signal is received from one of the nearby mobile devices in response indicating that the one of the different mobile devices is in the standby mode; and
establishing the silent communications link for the data transfer between the originating mobile device and the one of the nearby mobile devices via the mobile device.

11. A method of initializing mobile devices having silent chips enabling silent communications transmissions during standby mode using handover requests in a mobile telecommunications network, comprising:
transmitting an initialization signal from each of the mobile devices to a corresponding base station, the initialization signal comprising identifying information of each of the mobile devices;
receiving a tailored handover table for each of the mobile devices comprising a set of identifying information corresponding to the remaining mobile devices selected by the corresponding base station; and
entering the standby mode for each of the mobile devices after receiving the tailored neighboring list from the corresponding base station.

12. The method of claim 11, further comprising:
generating a master handover table using the corresponding base station which comprises entries of the identifying information of all of the mobile devices within a cell; and
generating the tailored handover table by selectively picking entries from the master handover table that are near each of the respective mobile devices.

13. The method of claim 11, wherein the initialization signal comprises a predetermined combination of identifiers including an operation code, a circuit identification code, an originating point code, a destination point code, a unique silent chip identifier number, phone number, silent chip model and firmware number, a last base station which the mobile device was communicating with, a current neighboring list table, a last usage time, a last handover serviced, a last handover requested or an identity of the corresponding base station.

14. The method of claim 11, wherein the entering the standby mode comprises:
updating the tailored handover table by periodically transmitting a new initialization signal to the corresponding base station; and
replacing the tailored handover table with a new tailored handover table in each of the mobile devices, where the new tailored handover table is received from the corresponding base station in response to the new initialization signal.

15. The method of claim 11, wherein the mobile devices are cellular telephones.

16. The method of claim 11, wherein the mobile devices are any one or any combination of cellular phones, a laptop computer, a hand-held computer, a Palm-sized computer, an PDA, or any Application Specific Device (ASD) that has wireless capabilities.

17. A telecommunications system, comprising:
mobile devices each configured to process data communications for other mobile devices when in a standby mode;
a base station controlling the data communications for the mobile devices within a cell of the telecommunications system; and
at least one silent buffering server to generate a master list of identifying information of all the mobile devices the cell and to generate a tailored list for each of the mobile devices comprising a selected set of the identifying information of nearby ones of the other mobile devices,
wherein each of the mobile devices is configured:
to receive from the base station the tailored list;
to transmit a handover request to a first one of the other mobile devices on the tailored list when the data communications are being processed; and
to establish a silent communications link for the data communications with the first one of the other mobile devices if the first one of the other mobile devices is in a standby mode.

18. The system of claim 17, wherein each of the mobile devices is further configured:
to transmit different handover requests to different mobile devices from the tailored list of the mobile device until one of the different other mobile devices is in the standby mode; and
to establish the silent communications link for the data communications with the one of the other different mobile devices.

19. The system of claim 18, wherein each of the mobile devices is further configured:
to transmit a new handover request to the base station in the cell of the telecommunications network after transmitting the different handover requests to a predetermined number of the different mobile devices and none of the predetermined number of the different mobile devices is in the standby mode; and
to pass the silent communications link for the data transfer to the base station, wherein the base station takes over the data communications for the mobile device.

20. A computer readable medium having stored thereon a plurality of instructions which, when executed by a mobile device in a wireless telecommunications network having at least one base station and associated other mobile devices, cause the mobile device to perform the steps of:
transmitting an initialization signal to the base station;
receiving a tailored neighboring list from the base station comprising a selected set of the associated other mobile devices that are nearest the mobile device; and
entering a standby mode after receiving the tailored neighboring list.
